(19) United States
(12) Patent Application Publication
(10) Pub. No.: US 2012/0178342 A1
(43) Pub. Date: Jul. 12, 2012

(54) TEXTILE BONDING ARRANGEMENTS

(76) Inventor: Richard Sturman, Nottinghamshire (GB)

(21) Appl. No.: 13/390,013

(22) PCT Filed: Aug. 12, 2010
(86) PCT No.: PCT/GB10/01527

§ 371 Date: Mar. 26, 2012

(30) Foreign Application Priority Data
Aug. 12, 2009 (GB) 0914046.8
Mar. 2, 2010 (GB) 1003441.1

(51) Int. Cl. A41C 1/14; B32B 37/12; D04B 21/20; B32B 1/08; D04B 1/24

(52) U.S. Cl. 450/52; 428/36.1; 156/148; 156/293; 156/221

(57) ABSTRACT

In the field of textile bonding arrangements there is a need to join a textile item to another item while maintaining the inherent flexibility of each item. A textile attachment formation (10; 50) comprises a textile structure (12) formed by a series of interlocking loops (14) of a first thread (16). The textile structure (12) further includes an elongate bonding element (20) which lies adjacent to the first thread (16). The position of the bonding element (20) about the perimeter (22) of the first thread (16) varies along the length of the first thread (16).

This invention relates to a textile attachment formation, a textile support assembly including an activated textile attachment formation, a casing assembly including the textile support assembly, a breast support arrangement including a textile support assembly or a casing assembly, a method of manufacturing a textile attachment formation, and a method of manufacturing a textile support assembly.

The use of adhesives for joining items together is well known. For example, adhesives in the form of a liquid or a tape may be used to join a textile item formed of natural or synthetic fibres to another textile item or another substrate.

The liquid or tape adhesive is formed in a pattern between the textile item and the other item and when the adhesive sets a bond is formed between the textile item and the other item.

One drawback with the conventional techniques mentioned above is that setting of the adhesive renders both the textile item and the other item stiff. This makes it difficult to process the combined items and renders any garment in which they are incorporated uncomfortable to wear.

According to a first aspect of the invention there is provided a textile attachment formation comprising a textile structure formed by a series of interlocking loops of a first thread, the textile structure further including an elongate bonding element lying adjacent to the first thread, the position of the bonding element about the perimeter of the first thread varying along the length of the first thread.

Varying the position of the elongate bonding element about the perimeter of the first thread means that discrete portions of the bonding element are exposed on a given side of the attachment formation. As a result when the bonding element is activated, e.g. melts before setting, discrete and discontinous bond formations are created on at least one side of the textile attachment formation.

These discrete bond formations are sufficient to bond the attachment formation to another substrate, or to allow an attachment formation lying between first and second substrates to bond the first and second substrates together. However, because the bond formations are discrete the textile attachment formation is able to retain the flexibility provided for by its interlocking loop structure, and so the or each substrate to which the textile attachment formation is bonded is similarly able to maintain any inherent flexibility.

Optionally the position of the bonding element relative to the perimeter of the first thread varies randomly. A random variation of position simplifies the manner in which the textile attachment formation may be manufactured while maintaining the formation of discrete bond formations on activation of the bonding element.

Preferably portions of the bonding element exposed on a first side of the textile structure define discrete bonding regions. Having a first side of the structure define discrete bonding regions ensures that the textile attachment formation is adherable to at least one substrate in a manner whereby the attachment formation and the substrate maintain their flexibility.

In a preferred embodiment of the invention the textile structure further includes a second thread lying alongside the first thread. The inclusion of a second thread allows the textile attachment formation to utilise two smaller diameter threads, so as to increase the inherent flexibility of the formation, while maintaining the same tensile strength as provided by a single, larger diameter thread.

In addition, the selective sandwiching of the elongate bonding element between the first and second threads results in the formation of bond formation (between the first and second threads) which is not exposed beyond the first and second threads. Such a hidden bond formation does not contribute to the bonding of the attachment formation to a substrate or between substrates and so further maintains the flexibility of the bonded arrangement.

At least one of the first thread and/or the second thread may be a multi-filament thread. The inclusion of a multifilament thread increases the inherent flexibility of the textile structure compared with the flexibility achieved with a monofilament thread of the same overall diameter. Furthermore, the spaces between adjacent filaments receive activated bonding element and so limit the amount of bonding element which is exposed on a given side of the textile attachment formation. This helps to ensure that the size of exposed bond formation is sufficient to ensure adequate adhesion but not so large as to degrade the flexibility of the bonded arrangement.

In another preferred embodiment of the invention the diameter of the elongate bonding element is smaller than the diameter of the first thread or both the first thread and the second thread. Having a smaller diameter bonding element helps to ensure that it is easily incorporated within the interlocking loops of the textile structure. It also limits the volume of bonding element that is introduced into the structure on activation of the bonding element.

Optionally the textile structure defines an elongate hollow structure. Having the textile structure define a hollow structure reduces the difficulties that might otherwise be associated with finishing edges of the textile attachment formation while maintaining a desired degree of flexibility.

In a further preferred embodiment of the invention the hollow structure is a hollow tubular structure. The inclusion of a hollow tubular structure helps to reduce kinking of the textile attachment formation, e.g. as it is formed into a pattern between substrates.

According to a second embodiment of the invention there is provided a textile support assembly, for a breast support arrangement, comprising a resiliently deformable curved support member including first and second ends, each of the first and second ends having an activated textile attachment formation as described hereinabove adhered thereto, the or each activated textile attachment formation being adhered to the support member by a plurality of discrete first bond formations.

The inclusion of at least one textile attachment formation allows the textile support assembly of the invention to be readily incorporated into a support arrangement, e.g. a breast support arrangement, via essentially conventional assembly steps, i.e. essentially conventional textile-based assembly steps.

Optionally the or each activated textile attachment formation defines an elongate hollow structure, each elongate hollow structure receiving a respective first or second end of the support member. The inclusion of an elongate hollow structure provides a convenient way of engaging the or each textile attachment formation with the corresponding end of the support member.

In a preferred embodiment of the invention the hollow structure of one activated textile attachment formation is integrally formed with the hollow structure of the other activated textile attachment formation. Such an arrangement allows the hollow structure to be constructed as a single article which streamlines manufacture of the textile support assembly, and so helps to reduce manufacturing costs.

Portions of the first thread may be bonded to one another by discrete second bond formations. Bonding portions of the first thread to one another helps to ensure that the or each elongate hollow structure remains in a desired configuration, e.g. in frictional engagement with the support member.

According to a third aspect of the invention there is provided a casing assembly, for a breast support arrangement, comprising a hollow tubular textile casing having first and second casing ends and within which lies a textile support assembly as described hereinabove, the or each activated textile attachment formation of the textile support assembly being secured relative to a corresponding casing end.

Securing the or each activated textile attachment formation in the aforementioned manner inhibits movement of the textile support assembly relative to the casing and so avoids incorrect positioning of the support member within the tubular textile casing and squeak difficulties.

Meanwhile the discrete and discontinuous nature of the bond formations means that the textile support assembly maintains its flexibility and so the casing assembly is comfortable when incorporated in a garment.

The or each activated textile attachment formation may be secured relative to a respective casing end by one or more stitches. Such stitches can be readily incorporated within a garment assembly process since stitching is very likely to be utilised elsewhere in the garment.

According to a fourth aspect of the invention there is provided a breast support arrangement incorporating a textile support assembly as described hereinabove.

According to a fifth aspect of the invention there is provided a breast support arrangement incorporating a casing assembly as described hereinabove.

The aforementioned breast support arrangements share the benefits associated with the corresponding textile support assembly and casing assembly.

According to a sixth aspect of the invention there is provided a method of manufacturing a textile attachment formation comprising the steps of:
(a) wrapping an elongate bonding element around a first thread, the position of the bonding element about the perimeter of the first thread varying along the length of the first thread; and
(b) forming the combined bonding element and first thread into a series of interlocking loops to create a textile structure.

Varying the position of the bonding element about the perimeter of the first thread means to that discrete portions of the bonding element are exposed, and so when the bonding element is activated discrete and discontinuous bond formations are created on at least one side of the textile attachment formation.

Such discrete bond formations are able to provide sufficient bonding while allowing the textile attachment formation to maintain its flexibility once bonding has taken place.

Optionally the step of wrapping an elongate bonding element around a first thread includes wrapping the elongate bonding element around the first thread in a random manner. Such a step reduces the control required in the manufacturing process and so allows it to be carried out using relatively simple machinery and relatively unskilled operatives.

According to a seventh aspect of the invention there is provided a method of manufacturing a textile support assembly comprising the steps of:
(a) providing a resiliently deformable support member having first and second ends;
(b) engaging a textile attachment formation as described hereinabove with each of the first and second ends; and
(c) activating the or each textile attachment formation to adhere the respective textile attachment formation to the corresponding first or second end via a plurality of discrete first bond formations.

Utilisation of a textile attachment formation as described hereinabove allows for the combining of the textile attachment formation and the support member while at the same time creating discrete bond formations between the two items. Such discrete bond formations, as mentioned above, provide a desired degree of bonding between items while maintaining the flexibility of the items.

Preferably the step of engaging the textile attachment formation with each of the first and second ends includes inserting each end into an elongate hollow structure of the or each textile attachment formation.

Such a step may be readily carried out by an automated manufacturing process.

A preferred method of manufacturing a textile support assembly further includes stretching the or each elongate hollow structure in a lengthwise direction to frictionally engage the said elongate hollow structure with at least a corresponding first or second end of the support member.

Stretching of the or each elongate hollow structure secures the or each structure to the support member to a desired initial extent.

Conveniently, activating the or each textile attachment formation includes melting the bonding element. Such activation can be readily carried out during a manufacturing process in a controlled manner, e.g. by heating and/or ultrasonic vibration.

There now follows a brief description of preferred embodiments of the invention, by way of non-limiting examples, with reference being made to the accompanying drawings in which:

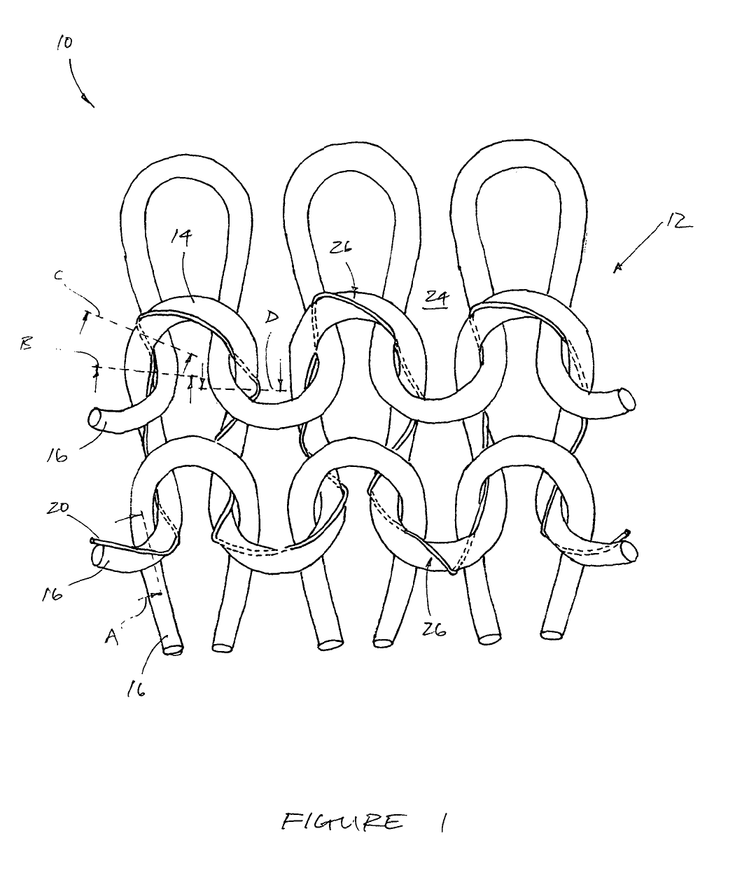

FIG. 1 shows an enlarged plan view from above of a portion of a textile attachment formation according to a first embodiment of the invention;

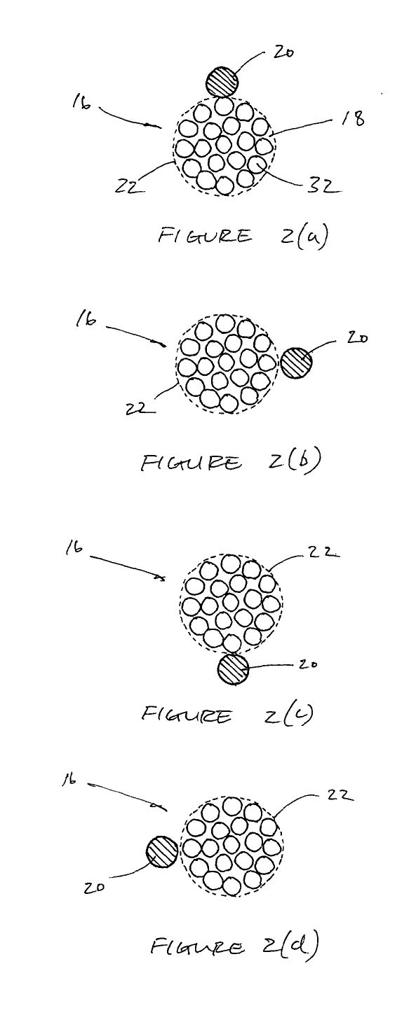

FIG. 2(a) shows a cross-sectional view through Section A-A of FIG. 1;

FIG. 2(b) shows a cross-sectional view through Section B-B of FIG. 1;

FIG. 2(c) shows a cross-sectional view through Section C-C of FIG. 1;

FIG. 2(d) shows a cross-sectional view through Section D-D of FIG. 1;

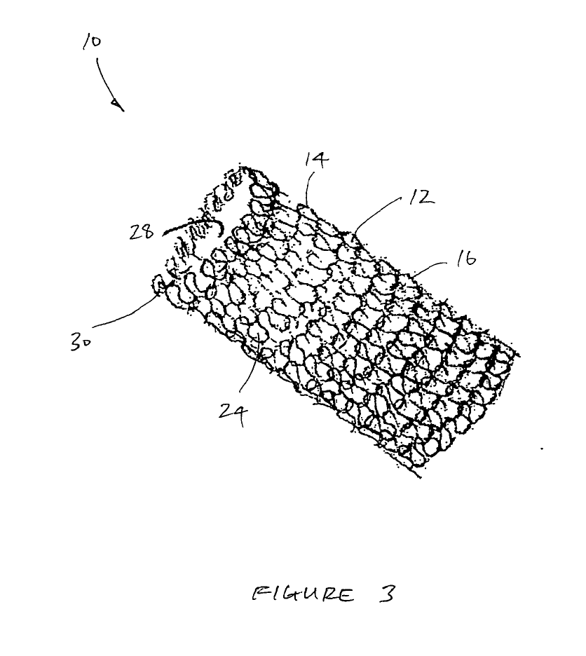

FIG. 3 shows a perspective view of the textile attachment formation shown in

FIG. 1;

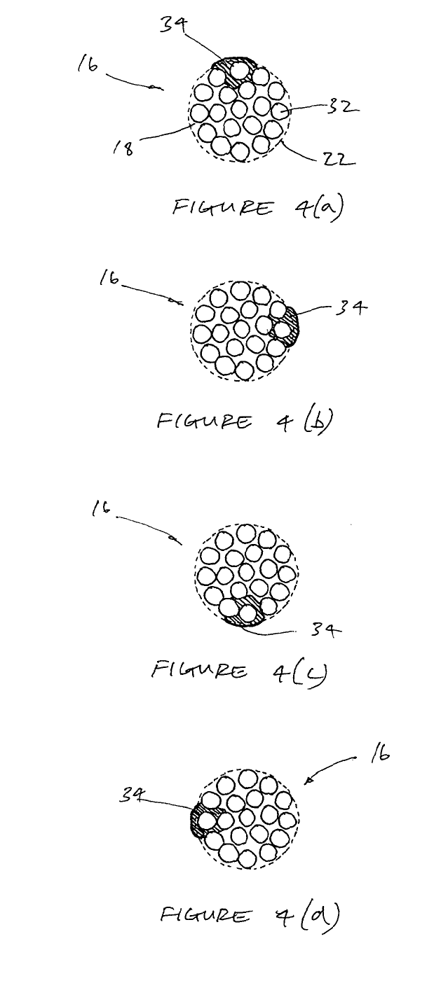

FIG. 4(a) shows the arrangement shown in FIG. 2(a) following activation of the bonding element;

FIG. 4(b) shows the arrangement shown in FIG. 2(b) following activation of the bonding element;

FIG. 4(c) shows the arrangement shown in FIG. 2(c) following activation of the bonding element;

FIG. 4(d) shows the arrangement shown in FIG. 2(d) following activation of the bonding element;

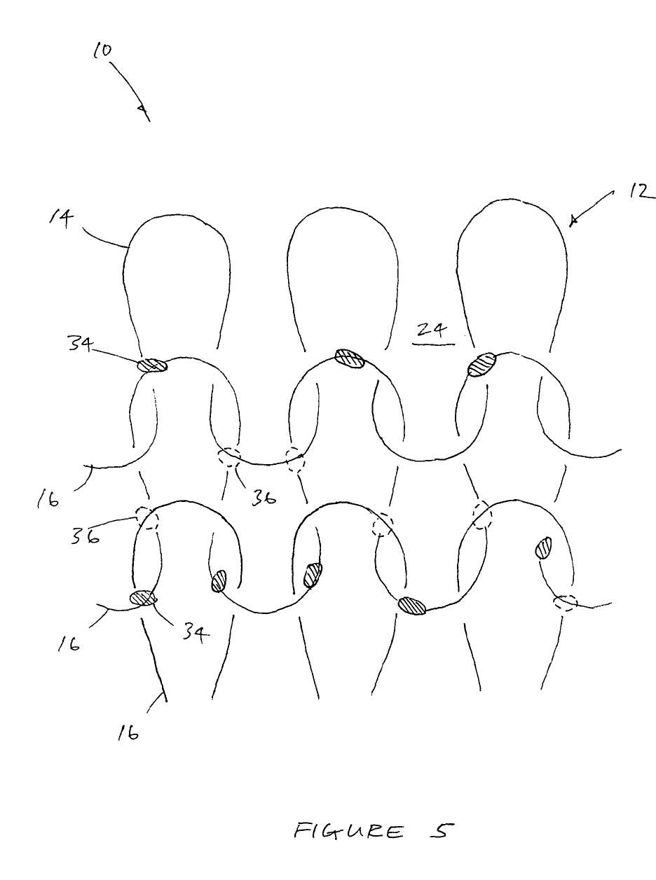

FIG. 5 shows a schematic view of the textile attachment formation shown in FIG. 1 following activation of the bonding element;

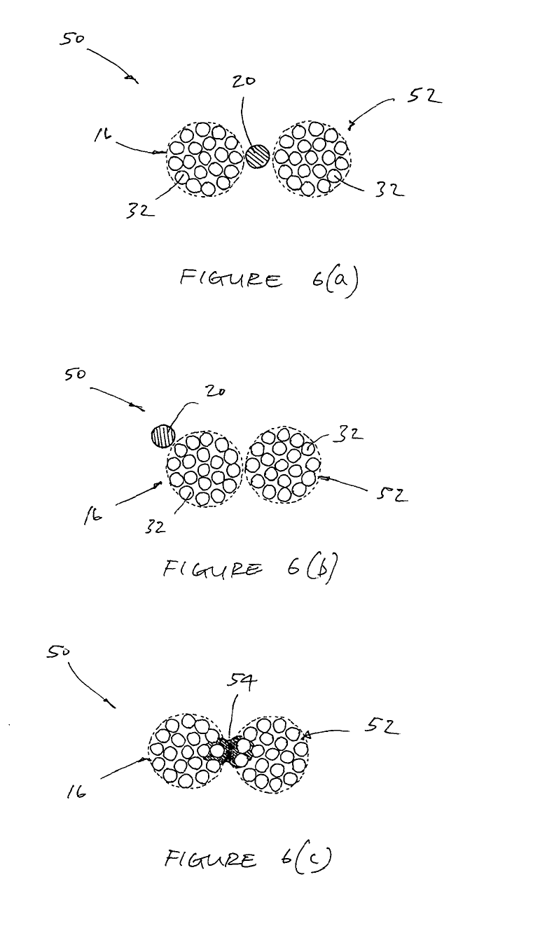

FIG. 6(a) shows a first cross-sectional view through a section of textile attachment formation according to a second embodiment of the invention;

FIG. 6(b) shows a second cross-sectional view through the textile attachment formation shown in FIG. 6(a);

FIG. 6(c) shows the arrangement shown in FIG. 6(a) following activation of the bonding element;

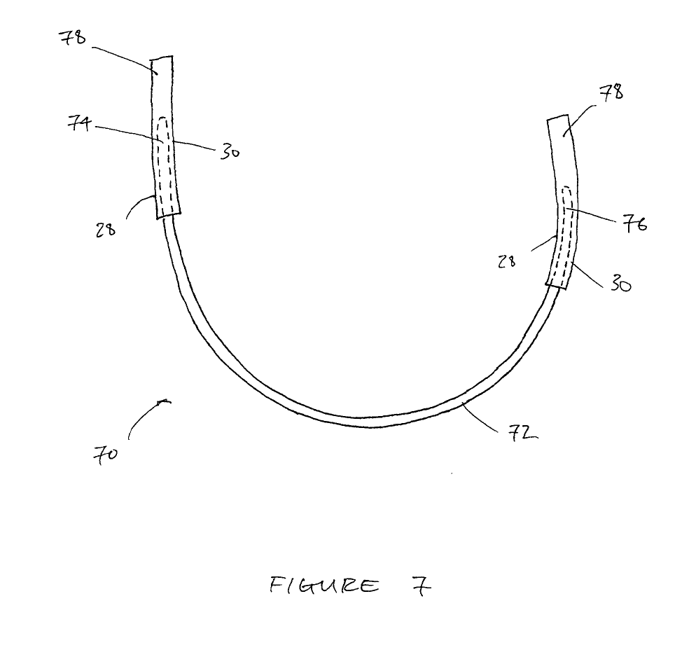

FIG. 7 shows a plan view from above of a textile support assembly according to a third embodiment of the invention;

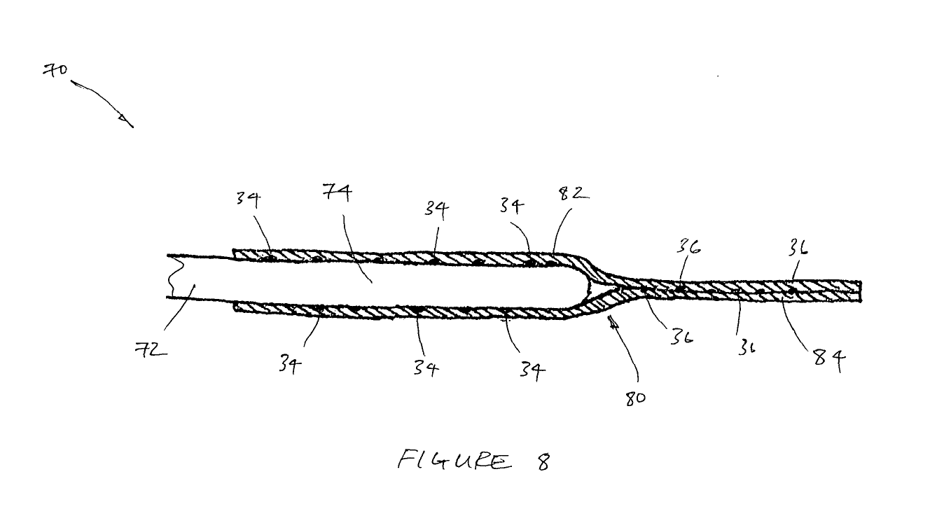

FIG. 8 shows a partially sectioned view from one side of the textile support assembly shown in FIG. 6;

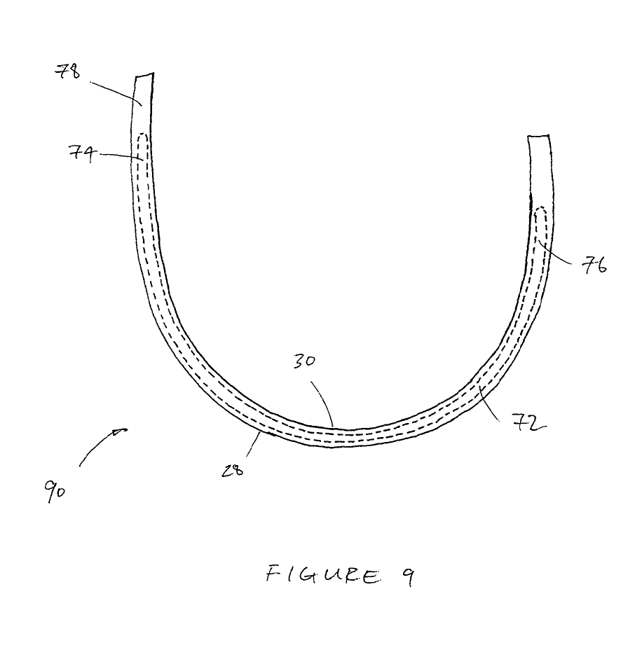

FIG. 9 shows a plan view from above of a textile support assembly according to a third embodiment of the invention; and

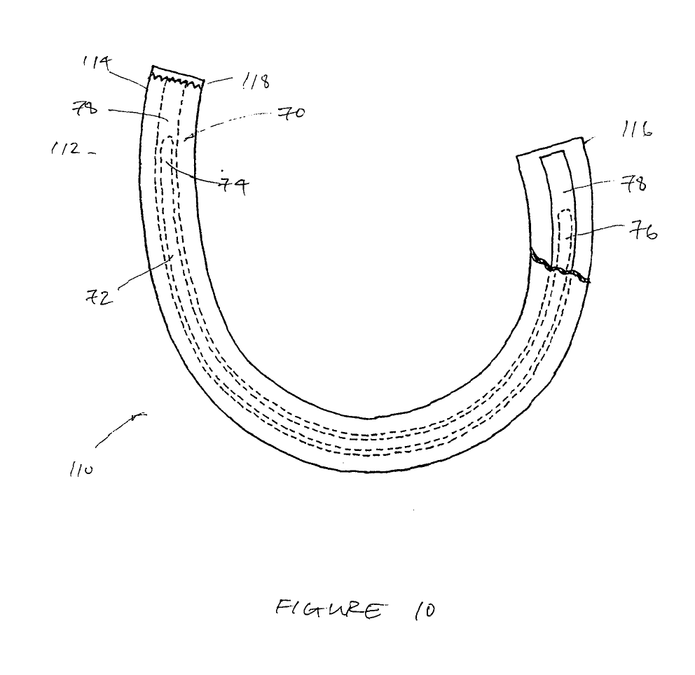

FIG. 10 shows a partially sectioned plan view from above of a casing assembly according to a fourth embodiment of the invention.

A textile attachment formation according to a first embodiment of the invention is designated generally by the reference numeral 10.

The textile attachment formation 10 has a textile structure 12 which is formed by a series of interlocking loops 14 of a first thread 16. In the embodiment shown the first thread 16 is a multi-filament sewing thread 18. In this context a sewing thread is a thread which achieves the minimum tenacity prescribed in ISO4915; 1991.

Suitable multifilament sewing threads 18 include polyamide or polyester threads such as Coats' Epic®, Gral® Delta®, or Seamsoft® threads, or Oxley's Lubrilox® or Aptan® threads.

In other embodiments of the invention (not shown) the first thread 16 may be a monofilament thread.

The textile structure 12 also includes an elongate bonding element 20 which lies adjacent to the first thread 16, as shown in FIG. 1 (bonding element 20 only shown on one course of loops 14 for clarity).

The bonding element 20 is or includes a thermoplastic material such as any of polyamide, polyester, polyurethane, polyurethane urea, or polypropylene, or a combination of any of these materials. Preferably the bonding element 20 is formed from a low melt, i.e. less than 110° C., monofilament yarn such as Luxilon Industries NV's Thermolux® yarn or EMS Chemie AG's Grilon® yarn.

The diameter of the bonding element 20 is smaller than the diameter of the first thread 16. In the embodiment shown the diameter of the bonding element 20 is approximately one fifth of the overall diameter of the first thread 16. In other embodiments of the invention (not shown) the ratio of the diameter of the first thread 16 to the diameter of the bonding element 20 can lie in the range 2:1 to 10:1.

The position of the bonding element 20 about the perimeter 22 of the first thread 16 varies along the length of the first thread 16, as shown in FIGS. 2(a) to 2(d). In the embodiment shown, the position of the bonding element 20 about the perimeter 22 varies randomly.

As can be seen in FIG. 1, a first side 24 of the textile structure 12 includes a number of regions in which a portion of the bonding element 20 is exposed. As such the first side 24 defines a plurality of discrete bonding regions 26.

The textile structure 12 also defines an elongate hollow structure 28, and in particular a hollow tubular structure 30, as shown in FIG. 3.

In use the textile attachment formation 10 is positioned as desired relative to a substrate, or between two substrates. The bonding element 20 is then activated, e.g. melted by heating. The bonding element 20 flows into the spaces between adjacent filaments 32 in the multifilament first thread 16, as shown in FIGS. 4(a) to 4(d). Each of the exposed discrete bonding regions created by the varying position of the bonding element 20 about the perimeter of the first thread 16, e.g. the exposed discrete bonding regions 26 on the first side 24 of the textile structure 12, form first discrete bond formations 34 which, when set, bond the textile attachment formation 10 to one or both substrates.

Second discrete bond formations 36 form between respective portions of the first thread 16 where the said portions overlap one another. These second bond formations help maintain the integrity of the textile structure 12.

The first and second discrete bond formations 34, 36 are sufficient to provide a desired degree of bonding but their discrete and discontinuous nature allows the textile attachment formation 10 to maintain the flexibility provided by its interlocking loop 14 structure and so, in turn, the or each substrate is able also to maintain its inherent flexibility.

FIG. 6(a) shows a cross-sectional view through a section of textile attachment formation 50 according to a second embodiment of the invention. The second textile attachment formation 50 shares a number of features with the first textile attachment formation 10 and these features are designated using the same reference numerals.

The second textile attachment formation 50 differs from the first textile attachment formation 10 in that its textile structure 12 is formed by a series of interlocking loops of first and second threads 16, 52. The second thread 52 is also a multifilament sewing thread 18 but the respective diameters of the first and second threads 16, 52 in the second textile attachment formation 50 are smaller than the diameter of the first thread 16 in the first textile attachment formation 10.

In use the second textile attachment formation 50 performs in a similar manner to the first textile attachment formation 10. The inclusion of two smaller diameter first and second threads 16, 52 means that the second textile attachment formation 50 can have the same tensile strength as the first textile attachment formation 10 but an even more flexible structure.

In addition, on activation of the bonding element 20 third bond formations 54 are created between overlapping first and second threads 16, 52, as shown in FIG. 6(c). These third bond formations 54 are not exposed and so do not contribute to the bonding of the second attachment formation 50 to one or more substrates.

Each of the first and second textile attachment formations 10; 50 is made by wrapping the elongate bonding element 20 around the first thread 16 so as to vary the position of the bonding element 20 about the perimeter 22 of the first thread 16 as the bonding element 20 extends along the length of the first thread 16. The combined bonding element 20 and first thread 16 is then formed into a series of interlocking loops 14 to create the textile structure 12.

The series of interlocking loops 14 may be formed by knitting, and in particular may be formed by a circular knitting machine. The bonding element 20 may be wrapped around the first thread 16 as it enters the knitting machine. Such wrapping tends to twist the bonding element 20 around the first thread 16 in a random manner.

A textile support assembly according to a third embodiment of the invention is designated generally by the reference numeral 70.

The textile support assembly 70 includes a resiliently deformable support member 72 that has first and second ends 74, 76, as shown in FIG. 7.

The support member 72 is formed from a metal. In other embodiments of the invention (not shown) the support member 72 may be formed from another resiliently deformable material such as a plastics material.

Each end 74, 76 has an activated textile attachment formation 78 secured relative thereto.

Each activated textile attachment formation 78 has essentially the same textile structure 12 as the first textile attachment formation 10 mentioned above. However, in activated form the bonding element 20 has been activated, e.g. melted, and so the textile structure 12 includes a plurality of discrete first and second bond formations 34, 36.

The elongate hollow structure 28 of each activated textile attachment formation 78 receives a respective first or second end 74, 76 of the support member 72.

In the embodiment shown, each elongate hollow structure 28 frictionally engages with the corresponding end 74, 76 of the support member 72.

Portions of the first thread 16 are bonded to one another by the discrete second bond formations 36 so as to maintain each elongate hollow structure 28 in frictional engagement with the corresponding end 74, 76 of the support member 72.

In addition, portions of the first thread 16 are bonded directly with the support member 72 via the plurality of discrete first bond formations 34.

The region of each activated textile attachment formation 78 which extends beyond the respective end 74, 76 of the support member 72 adopts a flattened cross-sectional profile.

The creation of discrete first and second bond formations 34, 36 means the whole of each activated textile attachment formation 78 maintains its flexibility, and allows for a smooth transition 80 between the support member engaging region 82 of each activated textile attachment formation 78 and the corresponding flattened region 84.

As mentioned above, each activated textile attachment formation 78 remains flexible and so can be readily penetrated by a sewing needle to allow securing of each formation 78 within a breast support arrangement by one or more stitches. The breast support arrangement may then, in turn, take the form of an article of clothing, an article of breast supporting underwear, or a brassiere.

A textile support assembly according to a fourth embodiment of the invention is designated generally by the reference numeral 90.

The second textile support assembly 90 shares a number of features with the first textile support assembly 70 and like features are designated using the same reference numerals.

In the second textile support assembly 90 the elongate hollow structure 28 of one activated textile attachment formation 78 is coupled with the elongate hollow structure 28 of the other activated textile attachment formation 78. In particular, the elongate hollow structures 28 are integrally formed with one another and together define a single hollow tubular structure 30.

The hollow tubular structure 30 frictionally engages with the whole of the support member 72 (shown in dashed line in FIG. 9).

Portions of the first thread 16 are bonded are bonded with one another by discrete second bond formations 36, so as to maintain the hollow tubular structure 30 in frictional engagement with the support member 72. Portions of the first thread 16 are also bonded directly with the support member 72 via discrete first bond formations 34.

In use, the respective ends of the activated textile attachment formation 78 allow ready securing of the support member 72 within a breast support arrangement via one or more stitches.

FIG. 10 shows a partially sectioned view of a casing assembly 110 according to another embodiment of the invention.

The casing assembly 110 includes a hollow tubular textile casing 112 which has first and second casing ends 114, 116. A suitable type of textile casing 112 is Fortitube® casing, as manufactured and sold by Stretchline UK Limited.

A second textile support assembly 90 lies within the textile casing 112. In other embodiments of casing assembly (not shown) a first textile support assembly 70 may lie within the textile casing 112.

Each end of the activated textile attachment formation 78 of the second textile support assembly 90 is secured relative to a corresponding casing end 114, 116.

In the embodiment shown, each end of the activated textile attachment formation 78 is secured by a plurality of stitches 118 (stitches only shown at a first casing end 114 for clarity).

In use, the flexible activated textile attachment formation 78 secures the second textile support assembly relative to the textile casing 112 to inhibit movement of the support assembly 90 within the textile casing 112.

The casing assembly 110 may be readily secured within a breast support arrangement, e.g. by stitching, as with conventional casing assemblies. The breast support arrangement may then, in turn, take the form of an article of clothing, an article of breast supporting underwear, or a brassiere.

The first textile support assembly 70 is manufactured by providing a resiliently deformable support member 72 which has first and second ends 74, 76, and by engaging a first textile attachment formation 10 to each of the first and second ends 74, 76.

Securing the first textile attachment formation 10 to each of the first and second ends 74, 76 is achieved by inserting each end 74, 76 into the hollow structure 28 of the corresponding first textile attachment formation 10.

Once each end 74, 76 of the support member 72 is inserted within a corresponding hollow structure 28, each hollow structure 28 is stretched in a lengthwise direction to frictionally engage the said hollow structure 28 with the corresponding first or second end 74, 76 of the support member 72.

The first textile support assembly 70 is then heated to melt the bonding element 20.

On cooling portions of the first thread 16 in each activated textile attachment formation 78 are bonded to one another by discrete second bond formations 36, and other portions of the first thread 16 are directly bonded with a corresponding first or second end 74, 76 of the support member 72 via respective discrete first bond formations 34.

The second textile support assembly 90 is manufactured in a similar manner to the first textile support assembly 70.

However, in the manufacture of the second textile support assembly 90 a single first textile attachment formation 10 is engaged with each of the first and second ends 74, 76.

1. A textile attachment formation comprising an elongate hollow textile structure formed by a series of interlocking loops of a first thread, the textile structure further including an elongate bonding element lying adjacent to the first thread, the position of the bonding element about the perimeter of the first thread varying along the length of the first thread.

2. A textile attachment formation according to claim 1 wherein the position of the bonding element relative to the perimeter of the first thread varies randomly.

3. A textile attachment formation according to claim 1 wherein portions of the bonding element exposed on a first side of the textile structure define discrete bonding regions.

4. A textile attachment formation according to claim 1 wherein the textile structure further includes a second thread lying alongside the first thread.

5. A textile attachment formation according to claim 4 wherein at least one of the first thread and/or the second thread is a multi-filament thread.

6. A textile attachment formation according to claim 4 wherein the diameter of the elongate bonding element is smaller than the diameter of the first thread or both the first thread and the second thread.

7. A textile attachment formation according to claim 1 wherein the textile structure defines an elongate hollow structure.

8. A textile attachment formation according to claim 6 wherein the hollow structure is a hollow tubular structure.

9. A textile support assembly, for a breast support arrangement, comprising a resiliently deformable curved support member including first and second ends, each of the first and second ends having an activated textile attachment formation according to claim 1 adhered thereto, the or each activated textile attachment formation being adhered to the support member by a plurality of discrete first bond formations.

10. A textile support assembly according to claim 9 wherein the elongate hollow structure of the or each textile attachment formation receives a respective first or second end of the support member.

11. A textile support assembly according to claim 10 wherein the hollow structure of one activated textile attachment formation is integrally formed with the hollow structure of the other activated textile attachment formation.

12. A textile support assembly according to claim 9 wherein portions of the first thread are bonded to one another by discrete second bond formations.

13. A casing assembly, for a breast support arrangement, comprising a hollow tubular textile casing having first and second casing ends and within which lies a textile support assembly according to claim 9 the or each activated textile attachment formation of the textile support assembly being secured relative to a corresponding casing end.

14. A casing assembly according to claim 13 wherein the or each activated textile attachment formation is secured relative to a respective casing end by one or more stitches.

15. A breast support arrangement incorporating a textile support assembly according to claim 9.

16. A breast support arrangement incorporating a casing assembly according to claim 13.

17. A method of manufacturing a textile attachment formation comprising the steps of:
(a) wrapping an elongate bonding element around a first thread, the position of the bonding element about the perimeter of the first thread varying along the length of the first thread; and
(b) forming the combined bonding element and first thread into a series of interlocking loops to create an elongate hollow textile structure.

18. A method of manufacturing a textile attachment formation according to claim 17 wherein the step of wrapping an elongate bonding element around a first thread includes wrapping the elongate bonding element around the first thread in a random manner.

19. A method of manufacturing a textile support assembly comprising the steps of:
(a) providing a resiliently deformable support member having first and second ends;
(b) engaging a textile attachment formation according to claim 1 with each of the first and second ends; and
(c) activating the or each textile attachment formation to adhere the respective textile attachment formation to the corresponding first or second end via a plurality of discrete first bond formations.

20. A method of manufacturing a textile support assembly according to claim 19 wherein the step of engaging the textile attachment formation with each of the first and second ends includes inserting each end into the elongate hollow structure of the or each textile attachment formation.

21. A method of manufacturing a textile support assembly according to claim 20 further including stretching the or each elongate hollow structure in a lengthwise direction to frictionally engage the said elongate hollow structure with at least a corresponding first or second end of the support member.

22. A method of manufacturing a textile support assembly according to claim 19 wherein activating the or each textile attachment formation includes melting the bonding element.

23-28. (canceled)
